(19) United States
(12) Patent Application Publication
(10) Pub. No.: US 2006/0223909 A1
(43) Pub. Date: Oct. 5, 2006

(54) Faster drying inkjet ink for porous and non-porous printing

(75) Inventors: Eda B. Wilson, Norwalk, CT (US); Deverakonda S. Sarma, Ridgefield, CT (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Illinois Tool Works Inc., Glenview, IL (US)

(21) Appl. No.: 11/096,148

(22) Filed: Mar. 31, 2005

(51) Int. Cl. C03C 17/00

(52) U.S. Cl. 523/160; 524/379

(57) ABSTRACT

The present invention provides improved performance inks for use in an impulse inkjet printer. The fast-drying compositions comprise from about 40 to about 55 percent by weight of a glycol alkyl ether having about 3 to 20 carbon atoms, about 30 to about 40 percent by weight of a solvent that is a ketone alcohol, 1,4-butanediol, ethanol, benzyl alcohol, alkyl lactates, or mixtures thereof; about 1 to about 10 percent by weight of glycerol; about 0.5 to about 5 percent by weight of a polymeric resin; about 0.5 to about 2 percent of one or more of surface modifiers and antioxidants; and about 1 to about 20 percent by weight of a colorant.

### FIELD OF THE INVENTION

The present invention relates to inkjet printers and, more particularly, to inks designed to prevent ink clogging in such printers.

### BACKGROUND OF THE INVENTION

Inkjet printing is performed by discharging ink droplets from a print head to a substrate. The droplets are ejected through orifices or nozzles in the print head and are directed to the substrate to form an image thereon. In contrast to many other types of printing, there is no contact between the printer and the substrate with inkjet printing.

Most of the inkjet printers known in the art may be characterized as either continuous, thermal, or impulse devices, depending upon the mechanism by which the ink droplets are directed to the substrate. In continuous inkjet systems, an essentially uninterrupted stream of ink is ejected from a nozzle and breaks up into droplets. The droplets bear an electric charge so that they can be deflected by an applied electric field which is modulated according to the particular image to be recorded. The electric field directs the droplets toward either the substrate or an ink re-circulating reservoir.

With so-called “impulse” or “drop-on-demand” inkjet printers, image formation is controlled by selectively energizing and de-energizing, for example, a piezoelectric transducer or solenoid rather than by modulating an applied electric field. Ink is stored in the print head or nozzle until it is necessary to form an image on the substrate. The printer is then activated by print signals to apply pressure to the ink and discharge a selected number of discrete ink droplets toward the substrate.

Because ink is ejected from impulse-type printers only periodically, these devices present a number of problems that typically are not encountered in continuous inkjet systems. Some problems occur during the relatively short intervals between individual print signals during a single print cycle. These include irregularly shaped drops and/or improper spacing of drops. The root cause of these problems may be attributable to movement of the ink meniscus at the time a print signal is generated, particularly where efforts are made to print at a frequency in excess of 3 KHz. One approach to these problems is presented by U.S. Pat. No. 4,266,232, in the name of Juliana, Jr., et al., which discloses an impulse printer where ink drops of substantially uniform size and spacing are generated by applying drive pulses in a mutually synchronous fashion at every one of predetermined equal intervals. The amplitude of the drive pulses is controlled so that the amplitude of the drive pulse is below that of a print signal when no drop is to be formed. Another approach is presented by U.S. Pat. No. 4,459,601, in the name of Howkins, wherein a fill-before-fire mode of operation is disclosed. In the disclosed method, a pulse of predetermined length is used to initiate filling of the jet chamber and firing of a droplet occurs on the trailing edge of the pulse.

Certain other problems associated with impulse inkjet printers relate to the considerably longer intervals between print cycles. Unlike continuous inkjet printers, impulse devices typically are maintained in stand-by or quiescent modes for relatively long intervals, sometimes on the order of seconds, minutes, and even hours. During these intervals, ink is allowed to stand, thicken due to evaporation of ink components, and possibly clog the nozzles of the print head. Impulse printers may begin a printing cycle with such thickened material in place. Many of the start-up problems encountered with impulse printers are attributable to ink which has been allowed to clog the nozzles during quiescent periods. Ink clogging is less of a concern in continuous systems because there typically are fewer interruptions in the flow of ink and any such interruption is of considerably shorter duration. Even where ink is allowed to stand and solidify in a continuous inkjet printer, it is more easily purged due to the considerably higher pressures at which these devices operate.

A number of methods and apparatus are known in the art for preventing clogging in inkjet printers during quiescent periods. For example, U.S. Pat. No. 4,970,527, in the name of Gatten, discloses an inkjet printer which prevents clogging by printing a few ink dots when the printer is idle. The method of Gatten, however, has the disadvantage of wasting both ink and printing substrate.

U.S. Pat. No. 3,925,789, in the name of Kashio, discloses an inkjet recording device which comprises a timer for determining the length of a quiescent period and a means for preliminarily ejecting ink from a nozzle if the quiescent period exceeds a predetermined amount of time. The ejected ink is not directed to a printing substrate but, rather, to an ink collector.

U.S. Pat. No. 4,540,997, in the names of Biggs, et al., discloses an inkjet printer wherein clogging is minimized by transporting the nozzles during quiescent periods to communicate with a wash station and then ejecting ink from the nozzles into the wash station if the printer has not functioned for a predetermined period of time.

U.S. Pat. No. 5,329,293, in the name of Liker, discloses an inkjet printer apparatus wherein clogging is minimized by pulsing the ink in the nozzle during quiescent periods. The pulsing signal provided is less than the size of a pulse signal that would cause ink to eject from the nozzle. This techniques is referred to as sub-pulsing. The sub-pulsing method and apparatus are effective and efficient in preventing ink from clogging the nozzle. However, with some extremely fast-drying inks, the sub-pulsing may lead to constant evaporation of solvents from the ink. As a result, all of the ink within the nozzle may suffer an increase in viscosity during the sub-pulsing period. Eventually the viscosity may increase too much and might adversely effect the operation of the printer.

U.S. Pat. No. 6,302,536, in the name of Sarma, et. al., discloses a fast drying composition for use in inkjet printing. This composition shows improved performance using a subpulsing routine to re-homogenize the viscosity barrier and keep the nozzle clean.

There exists a need for a composition that avoids inkjet clogging with maintaining fast drying times.

### SUMMARY OF THE INVENTION

The present invention provides fast-drying inkjet ink compositions for use in an impulse inkjet printer. The compositions comprise from about 40 to about 55 percent by weight of a glycol alkyl ether having about 3 to 20 carbon atoms, about 30 to about 40 percent by weight of a solvent that is a ketone alcohol, 1,4-butanediol, ethanol, benzyl alcohol, an alkyl lactate, or mixtures thereof; about 1 to about 10 percent by weight of glycerol; about 0.5 to about 5 percent by weight of a polymeric resin; and about 0.5 to about 2 percent of one or more of surface modifiers and antioxidants. The composition also contains about 1 to about 20 percent by weight of a colorant, or about 5 to about 15 percent by weight in some embodiments.

In some compositions, the glycol alkyl ether is one or more of ethylene glycol ethers, propylene glycol ethers, polyoxyethylene glycol ethers, and polyoxypropylene glycol ethers. In some preferred embodiments, the composition has about 44 to about 50 percent by weight of a propylene glycol ether.

Certain embodiments of the invention contain about 5 to about 8 percent by weight of glycerol.

A humectant can be present in an amount of 0 to about 15% by weight. Some preferred humectants are diols, triols, glycol ethers, esters, or a fatty acids.

One preferred ketone alcohol is diacetone alcohol. Some embodiments have about 33 to about 38 percent by weight of diacetone alcohol.

Certain embodiments of the invention have about 1 to about 2 percent by weight of polymeric resin. Suitable polymeric resins include polyester resins, polyvinylbuterol resins, phenolic resins, acrylic resins, polyamides, styrene acrylics and mixtures thereof.

Some compositions have a viscosity of about 5 to about 15 cps at 25° C., a surface tension of about 24 to about 35 dynes/cm at 23° C., and/or an optical density of about 1.2 to about 1.4.

The compositions of the instant invention can also contain an antioxidant. Such antioxidants can be present in an amount of about 0.5 to about 2 percent by weight.

Some preferred compositions comprise about 44 to about 50 percent by weight of a propylene glycol ether; about 33 to about 38 percent by weight of diacetone alcohol; about 4 to about 8 percent by weight of glycerol; about 0.5 to about 2 percent by weight of a polymeric resin; about 0.5 to 1.5 percent surface modifier; and about 10 to 16 percent by weight of a colorant. Yet other compositions comprise about 44 to about 46 percent by weight of propylene glycol methyl ether; about 35 to about 38 percent by weight of diacetone alcohol; about 4 to about 6 percent by weight of glycerol; about 0.5 to about 1.5 percent by weight of a polymeric resin; about 0.5 to 1.5 percent surface modifier; and about 10 to 12 percent by weight of a colorant.

The invention also relates to a method of operating an impulse inkjet printer having at least one nozzle comprising ejecting ink from said nozzle onto a substrate, said ink comprising:

about 40 to about 55 percent by weight of at least one glycol alkyl ether having about 3 to about 20 carbon atoms;

about 30 to about 40 percent by weight of a ketone alcohol, 1,4-butanediol, ethanol, benzyl alcohol, alkyl lactates, carbitol, or mixtures thereof;

about 1 to about 10 percent by weight of glycerol;

about 0.5 to about 5 percent by weight of a polymeric resin;

about 0.5 to about 2 percent of a surface modifier; and

about 1 to about 20 percent by weight of a colorant.

### BRIEF DESCRIPTION OF THE DRAWINGS

The foregoing summary, as well as the following detailed description of the preferred embodiments, are better understood when they are read in conjunction with the appended drawings. The drawings illustrate some preferred embodiments of the invention and are presented to certain illustrate aspects of the invention. The invention, however, should not be considered to be limited to the specific embodiments that are illustrated and disclosed.

FIG. 1 is a perspective view of an impulse inkjet printing apparatus.

FIG. 2 is a plan view of an orifice plate of the printing apparatus of FIG. 1.

### DETAILED DESCRIPTION OF PREFERRED EMBODIMENTS

The present invention provides inkjet ink compositions for use in an impulse inkjet printer. The fast-drying ink compositions comprise from about 40 to about 55 percent by weight of a glycol alkyl ether having about 3 to 20 carbon atoms, about 30 to about 40 percent by weight of a solvent that is a ketone alcohol, 1,4-butanediol, ethanol, benzyl alcohol, an alkyl lactate, or mixtures thereof; about 1 to about 10 percent by weight of glycerol; about 0.5 to about 5 percent by weight of a polymeric resin; about 0.5 to about 2 percent of one or more of surface modifiers and antioxidants; and about 1 to about 20 percent by weight of a colorant.

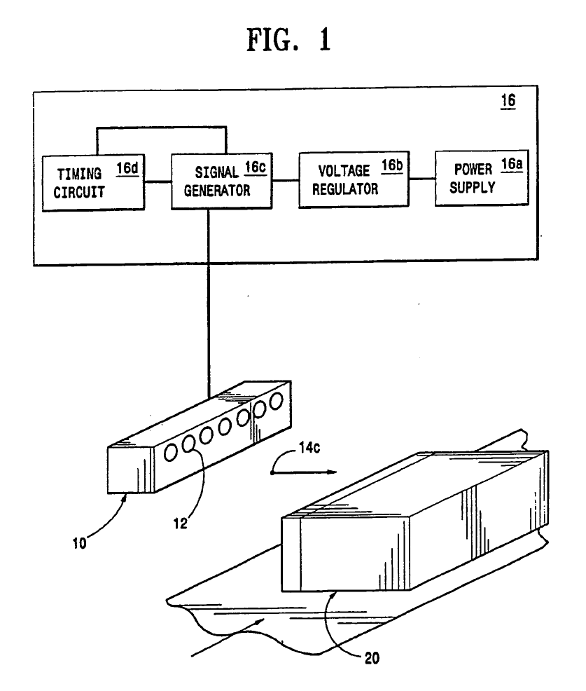

The compositions and methods of the present invention are particularly useful in conjunction with virtually any impulse or “drop-on-demand” inkjet printer which is subject to stand-by or quiescent periods. Referring to FIG. 1, a representative printing apparatus according to the present invention is shown comprising a print head 10 having a plurality of nozzles 12 and control means 16 electrically coupled with the print head.

Any of the wide variety of print heads known in the art may be employed in the present invention, so long as it comprises at least one nozzle which ejects ink droplets in response to control signals. It is preferred that the print head be of the piezoelectric type, more preferably 768Jet or UJII 192/32 printhead each of which are commercially available from Trident, Inc. of Brookfield, Conn.

The control means 16 may be any of those known in the art to be capable of generating control signals. As shown in FIG. 1, control means 16 preferably comprises a power source 16a, a voltage or current regulator 16b, a signal generator 16c, and a timing circuit 16d for determining the interval between firing signals. It is preferred that a voltage regulator be employed and that the signal generator generate signals initiated under software control. Control means amenable to the practice of this invention include computing devices such microprocessors, microcontrollers, capacitors, switches, circuits, logic gates, or equivalent logic devices. Preferred control means 16 include a personal computer coupled to a Trident 16-Channel Analog Driver Board, part number 016-7008-01, which is commercially available from Trident, Inc. The preferred driver board generates a control signal in the form of an RC time constant controlled waveform with a 13.0μ second leading pulse followed by a 5μ second off time and a 5μ second trailing pulse. U.S. Pat. No. 6,126,259, which is incorporated herein by reference, discloses firing waveforms for ejecting ink from an inkjet nozzle and includes the preferred firing pulse of the present invention.

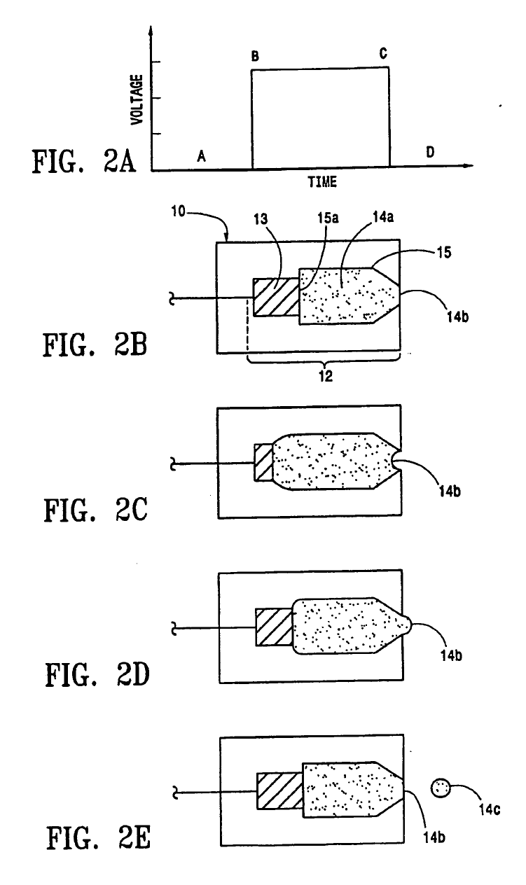

As shown in FIGS. 1 and 2A-2E, one or more ink droplets 14c can be ejected from the nozzles 12 toward substrate 20 by selectively energizing and de-energizing piezoelectric transducers 13. In preferred embodiments, each transducer 13 is attached to a membrane, sealant, or some other flexible member 15a in physical contact with a volume of ink 14a contained within chamber 15. The transducers are energized and de-energized through application of control signals. Although the control signal waveform could be selected from many known ink droplet firing signals, for brevity and simplicity of understanding, the firing control signal is shown in FIG. 2A in the form of a square wave.

The present invention provides improved ink compositions for use with drop-on-demand or impulse inkjet systems. The invention further provides inkjet ink compositions capable of printing clear, well-defined alphanumeric text and narrow bar width bar codes on porous and non-porous substrates. Throughout the description, the invention is described in connection with a solvent-based, black dye wherein the dye used is solvent black 3. However, the particular dye, and its associated color described herein, only illustrate the present invention and are not intended to be limitations. The invention is equally applicable to other colorants (both dye and pigments) as long as the performance characteristics as herein described are not adversely affected. Accordingly, the invention should not be limited to the particular pigment described as the invention contemplates the application of other pigments.

As used herein, numerical ranges preceded by the term “about” should not be considered to be limited to the recited range. Rather, numerical ranges preceded by the term “about” should be understood to include a range accepted by those skilled in the art for any given element in ink formulations according to the present invention.

When percentages of ingredients are presented herein, unless otherwise stated, the percent is the weight percent of that ingredient within the composition. Thus, if ingredient “X” is said to be present at 3%, the ingredient constitutes 3% by weight of the total weight of the composition.

The present invention provides fast-drying inkjet ink compositions for use in impulse inkjet printers. The fast-drying ink compositions comprise from about 40 to about 55 percent by weight of a glycol alkyl ether having about 3 to 20 carbon atoms, about 30 to about 40 percent by weight of a solvent that is a ketone alcohol, 1,4-butanediol, ethanol, benzyl alcohol, an alkyl lactate, or mixtures thereof; and about 1 to about 10 percent by weight of glycerol. The fast-drying inkjet ink compositions also comprise from about 0.5 to about 5 percent by weight of a polymeric resin and about 0.5 to about 2 percent of one or more of surface modifiers and antioxidants. The fast-drying inkjet ink compositions also comprise from about 1 to about 20 percent by weight of a colorant, about 5 to 15 percent by weight in some compositions.

Fast-drying ink compositions comprise a solvent or a combination of solvents. In some preferred embodiments, the composition comprises from about 40 to about 50 percent by weight of a solvent that a glycol alkyl ether having about 3 to 20 carbon atoms and about 33 to about 38 percent by weight of a solvent that is a ketone alcohol, 1,4-butanediol, ethanol, benzyl alcohol, an alkyl lactate, or mixtures thereof.

Preferred glycol alkyl ethers have about 3 to 20 carbon atoms, and in some embodiments, more preferably about 3-7 carbon atoms, and in other embodiments, most preferably 4 carbon atoms. One preferred glycol alkyl ether is propylene glycol methyl ether.

Ketone alcohols, 1,4-butanediol, denatured ethanol, benzyl alcohol, and alkyl lactates can be used as a solvent in the instant compositions. One preferred ketone alcohol is diacetone alcohol. Preferred alkyl lactates include ethyl lactate and butyl lactate.

The preferred fast-drying ink compositions of this invention further comprise from about 0.5 to about 5% by weight of a polymeric resin. Preferred polymeric resins include polyester resins, polyvinylbuterol resins, such as for example, MOWIFOL B3020H (commercially available from Hoechst, United Kingdom), phenolic resins, such as, for example, ALNOVOL PN 320 (commercially available from Hoechst, United Kingdom), and acrylic resins, such as styrene acrylic resin. Other suitable resins include polyamide and styrene acrylic resins. Another preferred resin is Joncryl 586, a low molecular weight, low acid number, solid styrene acrylic resin from Johnson Polymers. Suitable resins may also be a mixture of two or more of the aforementioned resins.

Ink compositions of the instant invention also comprise a colorant. The choice of colorant and its concentration principally depend on the solubility of the colorant and the intensity of its color for a particular application. Preferably, the colorant is selected to render the ink composition visible to the human eye or some mechanical data collection device, such as a bar code scanner or other type of optical character reader. A preferred colorant comprises a dye such as Oil Black 860 from Orient Chemical Industries, Ltd. Other preferred colorants include dyes such as DL Black 3029 and Orasol Black RLI, manufactured by Hubei DingLong Chemical Co., Ltd. and Ciba-Geigy Co Ltd. respectively. Preferably, the colorant comprises from about 1 to about 20% by weight of the ink composition. In some embodiments, the colorant is present in the composition in an amount of about 10 to about 16 percent by weight.

The instant compositions can comprise one or more humectants. These components are selected to be high boiling point solvents with slow evaporation at ambient conditions to control the ink drying in the print head orifices. Suitable humectants include diols, triols, glycol ethers, esters, fatty acids (such as triethylene glycol, tetraethylene glycol, diethylene glycol, butoxy glycol, ethylene glycol, glycerol, NMP, ethyl lacatate, and oleic acid).

Ethanol, in some embodiments, can be denatured ethanol.

Inks of the instant invention are designed to print on both porous and non-porous substrates. On porous substrates the ink dries primarily by absorption. On non-porous substrates the ink dries primarily by evaporation. On certain non-porous substrates the ink may take longer to dry but the drying time can be improved by using air or heat assistance.

There are two commonly used types of coated substrates—clay coated and UV coated. On UV coated the surface tension of the ink may be lower than 30 dynes/cm to wet the substrates and give a better print contrast. Surface modifiers used in this formulation will help to lower the surface tension there by improve wetting on the substrates.

Surface modifiers useful in the invention include silicon containing additives. Such modifiers include siloxane surfactants such as poly-dimethyl siloxanes. Examples of such modifiers include BYK 306, BYK 310, and BYK 348, polyether modified poly-dimethyl siloxane surfactants manufactured by BYK Chemie USA, Inc.

One skilled in the art will recognize that the fast-drying impulse inkjet ink formulations according to the present invention, not only readily form a viscosity barrier at the orifice of the nozzle as described above, but also eliminate the need for extraneous heating devices such as, for example, microwave heaters, forced hot air heaters, convection heaters, and the like, that are typically employed to increase the rate at which the ink dries on a substrate. Depending on the substrate that the ink is printed on and the process conditions, however, such drying may be optionally utilized.

The ink composition of this invention may further comprise additional additives or components in varying amounts, so long as incorporation of the additives or components does not change certain drying properties as described in further detail below.

In another embodiment of the present invention, the ink compositions of the present invention further comprise from about 0.01 to about 2, or about 0.01 to about 1 percent by weight of an antioxidant in some embodiments. In yet other embodiments, the antioxidant constitutes about 0.5 percent by weight of the ink composition.

The antioxidant may be selected for its ability to improve the dynamic throughput performance in the printhead. Cavitation is the formation of gas bubbles in a liquid and is caused by the presence of dissolved gases in the liquid. Inside of an impulse-type printhead, there is a piezo attached to a wall of a liquid chamber that expands and contracts causing an oscillating pressure field within the chamber. Formation of bubbles and the likelihood of their initial growth and subsequent shrinkage in the oscillating pressure field significantly reduce the printhead jetting performance.

It is desirable to control cavitation when using piezoelectric inkjet print heads having a higher number of orifices, such as, for example, the ULTRAJETII 192/32 printhead (commercially available from Trident International, Brookfield, Conn.) for at least two reasons. First, such larger printheads have a greater surface area which typically allows greater opportunity for evaporation. Second, the greater number of orifices typically increase the opportunity for air entrainment as a result of the operation of the piezo, as described above.

Suitable antioxidants for use with fast-drying inkjet ink compositions are disclosed in co-pending U.S. Pat. No. 6,439,709, which is incorporated herein by reference. Examples of such antioxidants include, for example, eugenol, hydroquinone, pyrocatechol, guaiacol (methyl catechol), butylated hydroxytoluene, butylated hydroxyanisole, methyl ethyl ketoxime, butylaldoxime, and cyclohexanone oxime.

While the instant inks are designed for use without the requirement of sub-pulsing or other techniques described in the art for preventing clogging in inkjet printers, such techniques may be optionally utilized with the instant inks. For example, the inks may be used with sub-pulsing techniques described in U.S. Pat. No. 6,302,536, which is incorporated herein by reference in its entirety.

### EXAMPLES

In the examples shown herein, the ink formulations were tested with 768Jet and UJII 192/32 printheads available from Trident, Inc. These printheads contain an auto maintenance system (AMS) that helps prevent the ink from drying in the nozzles, if left idle for prolonged periods. AMS compliments the sub-pulsing features used with previously disclosed faster drying ink formulations.

### Example 1

An inkjet ink composition that demonstrates the desired fast-drying properties was prepared by blending the following ingredients:

| | |
|---|---|
| Propylene Glycol Methyl Ether (solvent) | about 45% |
| Diacetone Alcohol (solvent) | about 36% |
| Glycerol | about 5% |
| Joncryl 586 (resin) | about 1% |
| Cyclohexanone Oxime (antioxidant) | about 0.5% |
| BYK 348 | about 0.25% |
| BYK 306 | about 0.5% |
| DYK Dynawet 800 | about 0.25% |
| Ding Long black 3029 (dye) | about 7% |
| Oil Black 860 (dye) | about 4%. |

This formulation has a viscosity of 6.2 cps at 25° C., a surface tension of 26.5 dynes/cm at 23° C., and an optical density of 1.35.

Viscosity was measured using Cone and plate rotational method using AR1000 Rheometer from TA instruments at a shear rate of 200 l/sec. ASTM # D 1986 D4287.

Surface tension was measured using du Nouy ring method using Fisher surface tensiomat Model # 21. ASTM D971.

Print contrast signal (PCS) was measured using 670 nm red laser Scan Chek barcode verifier from REA Instruments.

Dry time was measured using ASTM # D 1640-03—standard method for drying, curing film formation of organic coatings.

Optical density was measured using ASTM # E1349 PH 2.18 spectral condition for the measurements of optical density. Visual darkness is as it appears to the eye at standard office light conditions.

Dynamic testing was done by test firing a given image using 768Jet printhead for about five minutes at 4 kHZ frequency. Pass is when no channels were dropped out during the test period.

### Example 2

The following formulations (Table 1) were made and tested. Numbers in the table are weight percent of the composition. PM is propylene glycol methyl ether, DAA is diacetone alcohol, CHO is cyclohexanone oxime, DC7 is a defoamer form Dow Corning, DL3029 is Ding Long Black 3029, and OB 860 is Oil Black 860.

TABLE 1

| | A | B | C | D | E | F | G | H | I | J | K | L | M | N | O | P | Q |
|---|---|---|---|---|---|---|---|---|---|---|---|---|---|---|---|---|---|
| PM (%) | 45 | 50 | 45 | 45 | 45 | 45 | 50 | 45 | 45 | 45 | 45 | 45 | 45 | 0 | 50 | 47 | 49 |
| DAA (%) | 45 | 35 | 38 | 33 | 38 | 28 | 0 | 0 | 38 | 38 | 33 | 0 | 0 | 10 | 0 | 0 | 0 |
| Carbitol | 0 | 0 | 0 | 0 | 0 | 0 | 35 | 38 | 0 | 0 | 0 | 38 | 31.5 | 0 | 0 | 0 | 0 |
| Ethyl | 0 | 0 | 0 | 0 | 0 | 0 | 0 | 0 | 0 | 0 | 0 | 0 | 0 | 62.5 | 30 | 37 | 30.2 |
| lactate | | | | | | | | | | | | | | | | | |
| (%) | | | | | | | | | | | | | | | | | |
| nMP | 0 | 0 | 0 | 0 | 0 | 0 | 0 | 0 | 0 | 0 | 0 | 0 | 0 | 5 | 0 | 0 | 0 |
| TEG | 5 | 5 | 5 | 10 | 0 | 15 | 5 | 5 | 0 | 0 | 0 | 0 | 0 | 0 | 0 | 0 | 0 |
| glycerin | 0 | 0 | 0 | 0 | 5 | 0 | 0 | 0 | 5 | 5 | 5 | 5 | 8 | 5 | 5 | 5 | 5 |
| Joncryl | 0 | 0 | 1 | 1 | 1 | 1 | 1 | 1 | 1 | 1 | 1 | 0 | 1 | 1 | 1 | 1 | 1 |
| 586 | | | | | | | | | | | | | | | | | |
| CHO | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| Byk 348 | 0 | 0 | 0.5 | 0.5 | 0.5 | 0.5 | 0.5 | 0.5 | 0.5 | 0.5 | 0.5 | 0.5 | 0 | 0 | 0 | 0 | 0 |
| Dynawet | 0 | 0 | 0 | 0 | 0 | 0 | 0 | 0 | 0 | 1 | 0 | 0 | 2 | 0 | 0 | 0 | 0 |
| 800 | | | | | | | | | | | | | | | | | |
| DC 7 | 0 | 0 | 0 | 0 | 0 | 0 | 0 | 0 | 0 | 0.1 | 0 | 0 | 0 | 0 | 0 | 0 | 0 |
| Byk 310 | 0 | 0 | 0 | 0 | 0 | 0 | 0 | 0 | 0 | 2 | 0 | 0 | 2 | 2 | 1 | 1 | 1 |
| DL3029 | 10 | 7 | 7 | 7 | 7 | 7 | 7 | 7 | 7 | 7 | 8 | 7 | 8 | 8 | 8 | 8.4 | 8.4 |
| OB 860 | 0 | 3 | 3 | 3 | 3 | 3 | 3 | 3 | 4 | 4 | 7 | 4 | 4 | 4 | 4 | 4.4 | 4.4 |

Properties of the compositions in Table 1 are presented in the Table 2 below.

| Comp | A | B | C | D | E | F | H | I |
|---|---|---|---|---|---|---|---|---|
| Visc, | 5.2 | 5.4 | 6.2 | 6.8 | 5.8 | 7 | 6.4 | 5.8 |
| cps 25° C. | | | | | | | | |
| Surface | 33.2 | 33.5 | 33.2 | 34 | 32.6 | 33.9 | 34.2 | 33.9 |
| Tension, | | | | | | | | |
| dynes/cm | | | | | | | | |
| 22° C. | | | | | | | | |
| PCS (200 | 73-74 | 73-74 | 73-74 | 73-74 | 73-74 | 73-74 | 73-74 | 74-76 |
| dpi, kraft) | | | | | | | | |
| Dry time, | 3-6 | <5 | 3-6 | 5-10 | 5-10 | 5-10 | 5-10 | |
| coated | | | | | | | | |
| paper | | | | | | | | |
| Dry time, | >40 | 30-40 | >40 | >60 | >60 | >60 | >60 | 40-50 |
| yellow | | | | | | | | |
| stock | | | | | | | | |
| Visual | Lt | Lt | Lt | Lt | Lt | Lt | Lt | Lt |
| darkness, | | | | | | | | |
| yellow | | | | | | | | |
| stock | | | | | | | | |
| Dynamic, | P | P | P | P | P | P | P | P |
| 4 KHz, | | | | | | | | |
| Comp | J | K | L | M | N | O | P | Q |
| Visc, | 6.5 | 7.5 | 5.4 | 6.5 | 5.5 | 7.8 | 7.5 | 8 |
| cps 25° C. | | | | | | | | |
| Surface | 27.7 | 33.5 | 27.1 | 26.7 | 27.1 | 25.8 | 26.4 | 26.2 |
| Tension, | | | | | | | | |
| dynes/cm | | | | | | | | |
| 22° C. | | | | | | | | |
| PCS (200 | 74-76 | | | | | | | |
| dpi, kraft) | | | | | | | | |
| Dry time, | 5-10 | 15 | <5 | <5 | <5 | <5 | <5 | <5 |
| coated | | | | | | | | |
| paper | | | | | | | | |
| Dry time, | 40-50 | 40-50 | 20-30 | 20-30 | <20 | 20-30 | 20-30 | 20-30 |
| yellow | | | | | | | | |
| stock | | | | | | | | |
| Visual | G | G | G | G | | Lt | Lt | Lt |
| darkness, | | | | | | | | |
| yellow | | | | | | | | |
| stock | | | | | | | | |
| Dynamic, | P | P | F | | F | | | F |
| 4 KHz, | | | | | | | | |

where
P = pass,
F = fail,
Lt = light,
G = good, and
visc = viscosity.

### Example 3

The ink of Example 1 was printed on a variety of substrates using a 768Jet printhead with AMS feature. Results are shown in the table below.

| | | Dry Time | Dry Time | | Barcode |
|---|---|---|---|---|---|
| | | Un- | Air- | Ad- | Readability |
| Substrate | | assisted | Assisted | he- | PCS % |
| Type | Substrate | (sec) | (sec) | sion | at 200 dpi |
| Porous | Plain paper | <1 | N/A | Good | 86-87% |
| Porous | Corrugated | <1 | N/A | Good | 86-87% |
| | Box | | | | |
| Semi-porous | Clay coated | 5-10 | N/A | Good | 88-91% |
| | box | | | | |
| Non-porous | Glass | 40-45 | 13-15 | Poor | |
| Non-porous | Soda can | 35-40 | 10-12 | Good | |
| Non-porous | Paint can lid | 40-45 | 12-14 | Good | |
| Non-porous | Soda bottle, | 40-45 | 8-10 | Good | |
| | PETE | | | | |
| Non-porous | Milk bottle, | 50-55 | 12-15 | Good | |
| | HDPE | | | | |
| Non-porous | Shrink wrap, | 55-60 | 8-10 | Good | |
| | PE | | | | |
| Non-porous | Valeron ® | 45-50 | 10-13 | Good | |
| | film | | | | |
| Non-porous | Packaging | 60-65 | 101-2 | Good | |
| | film, PE | | | | |
| Wax coated | Milk carton | 5-10 | N/A | Good | |
| UV coated | European | 50-55 | 101-5 | Good | 78% |
| | wine box | | | | |
| UV coated | Wine bottle | 60-65 | 15-20 | Good | 72% |
| UV coated | Wine bottle | 50-55 | 15-20 | Good | 86% |

In the above table, PE is polyethylene, HDPE is high density polyethylene, and PETE is polyethylene terephthalate. Such compositions are well known to those skilled in the art. Valeron is the registered trademark for a plastic film marketed by Illinois Tool Works of Glennview, Ill.

All patents and references cited herein are incorporated by reference in their entirety.

What is claimed is:

1. A fast drying ink composition, for use in impulse inkjet printers, comprising:
about 40 to about 55 percent by weight of at least one glycol alkyl ether having about 3 to about 20 carbon atoms,
about 30 to about 40 percent by weight of a ketone alcohol, 1,4-butanediol, ethanol, benzyl alcohol, alkyl lactates, carbitol, or mixtures thereof;
about 1 to about 10 percent by weight of glycerol
about 0.5 to about 5 percent by weight of a polymeric resin;
about 0.5 to about 2 percent of one or more of surface modifiers and antioxidants; and
about 1 to about 20 percent by weight of a colorant.

2. The composition of claim 1 wherein said glycol alkyl ether comprises ethylene glycol ethers, propylene glycol ethers, polyoxyethylene glycol ethers, polyoxypropylene glycol ethers, or mixtures thereof.

3. The composition of claim 1 comprising about 44 to about 50 percent by weight of a propylene glycol ether.

4. The composition of claim 1 additionally comprising up to about 15% by weight of at least one of a diol, triol, glycol ether, esters, or a fatty acid.

5. The composition of claim 1 comprising about 5 to 15 percent by weight of a colorant.

6. The composition of claim 1 wherein said ketone alcohol comprises diacetone alcohol which is present at about 33 to about 38 percent by weight

7. The composition of claim 1 comprising about 1 to about 2 percent by weight of polymeric resin.

8. The composition of claim 1 wherein the polymeric resin is a polyester resin, a polyvinylbuterol resin, a phenolic resin, an acrylic resin, polyamide, styrene acrylics or mixtures thereof.

9. The composition of claim 1 having a viscosity of 5 to 15 cps at 25° C., a surface tension of 24 to 35 dynes/cm at 23° C., and an optical density of 1.2 to 1.4.

10. The composition of claim 1 comprising about 44 to about 50 percent by weight of a propylene glycol ether; about 33 to about 38 percent by weight of diacetone alcohol; about 4 to about 8 percent by weight of glycerol; about 0.5 to about 2 percent by weight of a polymeric resin; about 0.5 to 1.5 percent surface modifier; and about 10 to 16 percent by weight of a colorant.

11. The composition of claim 1 comprising about 44 to about 46 percent by weight of propylene glycol methyl ether; about 35 to about 38 percent by weight of diacetone alcohol; about 4 to about 6 percent by weight of glycerol; about 0.5 to about 1.5 percent by weight of a polymeric resin; about 0.5 to 1.5 percent surface modifier; and about 10 to 12 percent by weight of a colorant.

12. The composition of claim 11 having a viscosity of 5 to 15 cps at 25° C., a surface tension of 24 to 35 dynes/cm at 23° C., and an optical density of 1.2 to 1.4.

13. A method of operating an impulse inkjet printer having at least one nozzle comprising ejecting ink from said nozzle onto a substrate, said ink comprising:
about 40 to about 55 percent by weight of at least one glycol alkyl ether having about 3 to about 20 carbon atoms,
about 30 to about 40 percent by weight of a ketone alcohol, 1,4-butanediol, ethanol, benzyl alcohol, alkyl lactates, carbitol, or mixtures thereof;
about 1 to about 10 percent by weight of glycerol;
about 0.5 to about 5 percent by weight of a polymeric resin;
about 0.5 to about 2 percent of a surface modifier; and
about 1 to about 20 percent by weight of a colorant.

14. The method of claim 13 wherein said ink comprises about 44 to about 50 percent by weight of a propylene glycol ether.

15. The method of claim 13 wherein said ink comprises about 5 to about 8 percent by weight of glycerol.

16. The method of claim 13 wherein said ink comprises about 10 to 16 percent by weight of a colorant.

17. The method of claim 13 wherein said ink comprises about 33 to about 38 percent by weight of diacetone alcohol.

18. The method of claim 13 wherein said polymeric resin is a polyester resin, a polyvinylbuterol resin, a phenolic resin, an acrylic resin, polyamide, styrene acrylics or mixtures thereof.

19. The method of claim 13 wherein said ink comprises about 44 to about 50 percent by weight of a propylene glycol ether; about 33 to about 38 percent by weight of diacetone alcohol; about 4 to about 8 percent by weight of glycerol; about 0.5 to about 2 percent by weight of a polymeric resin; about 0.5 to 1.5 percent surface modifier; and about 10 to 16 percent by weight of a colorant.

20. The method of claim 13 wherein said ink comprises about 44 to about 46 percent by weight of propylene glycol methyl ether; about 35 to about 38 percent by weight of diacetone alcohol; about 4 to about 6 percent by weight of glycerol; about 0.5 to about 1.5 percent by weight of a polymeric resin; about 0.5 to 1.5 percent surface modifier; and about 10 to 12 percent by weight of a colorant.
